(19) United States
(12) Patent Application Publication
(10) Pub. No.: US 2025/0182140 A1
(43) Pub. Date: Jun. 5, 2025

(54) METHODS AND SYSTEMS FOR DISTRIBUTING VEHICLE COVERAGE

(71) Applicant: Frank T. O'Keefe, Lloyd Harbor, NY (US)

(72) Inventor: Frank T. O'Keefe, Lloyd Harbor, NY (US)

(21) Appl. No.: 19/043,769

(22) Filed: Feb. 3, 2025

Related U.S. Application Data
(63) Continuation of application No. 17/653,505, filed on Mar. 4, 2022, now abandoned.
(60) Provisional application No. 63/156,744, filed on Mar. 4, 2021.

(51) Int. Cl. G06Q 30/018; B60L 53/66; G06Q 30/0207

(52) U.S. Cl. CPC G06Q 30/018; B60L 53/665; G06Q 30/0222; G06Q 30/0224; Y02P 90/90

(57) ABSTRACT

Methods and systems are described that provide disruptive models for distributing vehicle coverage while providing fuel suppliers and/or vehicle manufacturers with profitable new revenue streams, while potentially eliminating third-party insurance brokers to reduce costs and directly connecting the cost of vehicle coverage to the risk associated with individual vehicle operators.

### CROSS-REFERENCE TO RELATED APPLICATIONS

The present application is a continuation of U.S. patent application Ser. No. 17/653,505, filed Mar. 4, 2022, which claims priority to U.S. Provisional Application No. 63/156,744, filed Mar. 4, 2021, the disclosures of which are hereby incorporated by reference in their entirety.

### BACKGROUND

The present disclosure relates generally to methods and systems for providing vehicle coverage (e.g., auto insurance) as part of, for example, a purchase of fuel for the vehicle from a fuel provider, or as part of the purchase of the vehicle itself from a vehicle manufacturer. The disclosed methods and systems provide disruptive models for distributing vehicle coverage while providing fuel suppliers and/or vehicle manufacturers with profitable new revenue streams, potentially eliminating “middle-men” or third-party insurance brokers to reduce costs, and directly connecting the cost of vehicle coverage to the risk associated with individual vehicle operators.

### SUMMARY

Disclosed herein are methods comprising: a) providing a plurality of fueling stations, wherein the fueling stations of the plurality are configured to provide one or more types of fuel to one or more types of vehicle, and wherein each of the one or more types of vehicle may have a different mileage value for the one or more types of fuel; b) upon or subsequent to an event comprising a vehicle of the one or more types of vehicle receiving one or more types of fuel at a fueling station of the plurality, collecting: (i) fuel data comprising data for an amount of fuel received by the vehicle as measured by one or more fueling station sensors, and (ii) vehicle data comprising data for a vehicle identification number and data for a mileage value as measured by one or more vehicle sensors; c) determining, using a processor, a vehicle coverage value for the event based at least in part on the fuel data and the vehicle data; and d) providing vehicle coverage in an amount equal to the vehicle coverage value to an operator of the vehicle. In some embodiments, the plurality of fueling stations comprise gasoline stations, electric vehicle recharging stations, or any combination thereof. In some embodiments, the plurality of fueling stations is provided by a fuel company or vendor that underwrites, administers, and provides customer service for the vehicle coverage. In some embodiments, the plurality of fueling stations is provided by a fuel company or vendor that underwrites the vehicle coverage, and at least one other company administers and provides customer service for the vehicle coverage. In some embodiments, the plurality of fueling stations is provided by a fuel company or vendor, and at least one other company underwrites, administers, and provides customer service for the vehicle coverage. In some embodiments, the vehicle coverage value is optionally tied to the use of a credit card provided by the fuel company or vendor that provides the plurality of fueling stations. In some embodiments, the vehicle coverage value is optionally tied to the use of a mobile phone payment system provided by the fuel company or vendor that provides the plurality of fueling stations. In some embodiments, the vehicle coverage value is optionally tied to a membership payment system provided by the fuel company or vendor that provides the plurality of fueling stations. In some embodiments, the vehicle coverage value is optionally tied to a vehicle identification number system provided by the fuel company or vendor that provides the plurality of fueling stations. In some embodiments, the vehicle coverage value is adjusted according to the type of vehicle. In some embodiments, the vehicle coverage value is adjusted according to an accident risk assessment based at least in part on an age of the vehicle operator. In some embodiments, the vehicle coverage is adjusted according to an accident risk assessment based at least in part on a sex of the vehicle operator. In some embodiments, the vehicle coverage is adjusted according to an accident risk assessment based at least in part on a geographical location of the vehicle operator. In some embodiments, the vehicle coverage is adjusted according to an accident risk assessment based at least in part on an average annual mileage driven by the vehicle operator. In some embodiments, the vehicle coverage is adjusted according to an accident risk assessment based at least in part on a driving record for the vehicle operator. In some embodiments, the vehicle coverage is adjusted according to a number of incident-free miles driven by the vehicle operator. In some embodiments, the vehicle coverage is adjusted based on historical data for traffic incidents along a prescribed route of travel. In some embodiments, the vehicle owner or user is offered alternative travel routes according to an accident risk assessment based at least in part on the prescribed driving route. In some embodiments, the prescribed driving route is provided by the vehicle operator upon entering a starting location and a destination into a computer program or mobile phone application. In some embodiments, the starting location is the location of the fueling station at which the receiving of the one or more types of fuel by the vehicle occurs. In some embodiments, the computer program or mobile phone application computes an accident frequency for two or more alternative driving routes between the starting location and the destination and selects the driving route for which the accident frequency is lowest as the projected driving route. In some embodiments, the computer program or mobile phone application computes a risk factor that is proportional to both an accident frequency and a driving time estimate that are calculated for two or more alternative driving routes between the starting location and the destination and selects the driving route for which the risk factor is lowest as the projected driving route. In some embodiments, the prescribed or alternative driving route is adjusted according to the time of day at which the vehicle operator plans to travel. In some embodiments, the prescribed or alternative driving route is adjusted according to the day of the week on which the vehicle operator plans to travel.

Also disclosed herein are methods for selling automobile insurance comprising: a) providing a plurality of fueling stations; and b) providing automobile insurance to a customer as part of a fuel purchase by the customer at any fueling station within the plurality; wherein an amount of automobile insurance provided as part of the purchase is proportional to an amount of fuel purchased. In some embodiments, the fueling station comprises a gasoline station or an electric vehicle recharging station. In some embodiments, the plurality of fueling stations is provided by a fuel company or a vendor that underwrites, administers, and provides customer service for the automobile insurance. In some embodiments, the plurality of fueling stations is provided by a fuel company or a vendor that underwrites the automobile insurance, and at least one other company administers and provides customer service for the automobile insurance. In some embodiments, the plurality of fueling stations is provided by a fuel company or a vendor, and at least one other company underwrites, administers, and provides customer service for the automobile insurance. In some embodiments, the fuel purchase by the customer is optionally tied to the use of a credit card provided by the fuel company or the vendor that provides the plurality of fueling stations. In some embodiments, the fuel purchase by the customer is optionally tied to the use of a mobile phone payment system provided by the fuel company or the vendor that provides the plurality of fueling stations. In some embodiments, the fuel purchase by the customer is optionally tied to a membership payment system provided by the fuel company or the vendor that provides the plurality of fueling stations. In some embodiments, the fuel purchase by the customer is optionally tied to a vehicle identification number system provided by the fuel company or the vendor that provides the plurality of fueling stations. In some embodiments, the amount of automobile insurance provided as part of the purchase is adjusted according to a type of automobile or electric vehicle owned or operated by the customer. In some embodiments, the amount of automobile insurance provided as part of the purchase is adjusted according to an accident risk assessment based at least in part on an age of the customer. In some embodiments, the amount of automobile insurance provided as part of the purchase is adjusted according to an accident risk assessment based at least in part on a sex of the customer. In some embodiments, the amount of automobile insurance provided as part of the purchase is adjusted according to an accident risk assessment based at least in part on a geographical location of the customer's place of residence. In some embodiments, the amount of automobile insurance provided as part of the purchase is adjusted according to an accident risk assessment based at least in part on an average annual mileage driven by the customer. In some embodiments, the amount of automobile insurance provided as part of the purchase is adjusted according to an accident risk assessment based at least in part on a driving record for the customer. In some embodiments, the amount or cost of the automobile insurance provided is adjusted according to a number of incident-free miles driven by the customer. In some embodiments, the amount of automobile insurance provided as part of the purchase is adjusted based on historical data for traffic incidents along a prescribed route of travel. In some embodiments, the customer is offered alternative travel routes according to an accident risk assessment based at least in part on the prescribed driving route. In some embodiments, the prescribed driving route is provided by the customer upon entering a starting location and a destination into a computer program or mobile phone application by the customer. In some embodiments, the starting location is the current location of the customer at which the fuel purchase is made. In some embodiments, the computer program or mobile phone application computes an accident frequency for two or more alternative driving routes between the starting location and the destination and selects the driving route for which the accident frequency is lowest as the projected driving route. In some embodiments, the computer program or mobile phone application computes a risk factor that is proportional to both an accident frequency and a driving time estimate that are calculated for two or more alternative driving routes between the starting location and the destination and selects the driving route for which the risk factor is lowest as the projected driving route. In some embodiments, the prescribed or alternative driving route is adjusted according to the time of day at which the customer plans to travel. In some embodiments, the prescribed or alternative driving route is adjusted according to the day of the week on which the customer plans to travel.

Disclosed herein are methods for selling insurance comprising: a) providing insurance to a customer as part of a vehicle purchase from a manufacturer of the vehicle. In some embodiments, the insurance comprises personal liability insurance, collision insurance, uninsured vehicle operator insurance, underinsured vehicle operator insurance, medical payments coverage insurance, personal injury protection insurance, gap insurance, comprehensive insurance, or any combination thereof. In some embodiments, the vehicle comprises an automobile, an autonomous automobile, a motorcycle, a motorized scooter, an electric bicycle, a boat, an airplane, a helicopter, or a drone. In some embodiments, the vehicle comprises an electric vehicle. In some embodiments, the manufacturer of the vehicle underwrites, administers, and provides customer service for the insurance. In some embodiments, the manufacturer of the vehicle underwrites the insurance, and at least one other company administers and provides customer service for the insurance. In some embodiments, an amount or cost of the insurance provided as part of the vehicle purchase is adjusted according to an accident risk assessment based at least in part on an age of the customer. In some embodiments, an amount or cost of the insurance provided as part of the vehicle purchase is adjusted according to an accident risk assessment based at least in part on a sex of the customer. In some embodiments, an amount or cost of the insurance provided as part of the vehicle purchase is adjusted according to an accident risk assessment based at least in part on a geographical location of the customer's place of residence. In some embodiments, an amount or cost of the insurance provided as part of the vehicle purchase is adjusted according to an accident risk assessment based at least in part on an average annual mileage driven by the customer or an average annual number of hours flown by the customer. In some embodiments, an amount or cost of the insurance provided as part of the vehicle purchase is adjusted according to an accident risk assessment based at least in part on a driving incident record or flight incident record for the customer. In some embodiments, an amount or cost of the insurance provided is adjusted according to a number of incident-free miles driven by the customer or according to a number of incident-free hours flown by the customer.

### INCORPORATION BY REFERENCE

All publications, patents, and patent applications mentioned in this specification are herein incorporated by reference in their entirety to the same extent as if each individual publication, patent, or patent application was specifically and individually indicated to be incorporated by reference in its entirety. In the event of a conflict between a term herein and a term in an incorporated reference, the term herein controls.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 provides a schematic illustration of a system for providing vehicle coverage through fuel purchases by a customer of a fuel company or fuel vendor.

FIG. 2 provides a schematic illustration of a system for providing vehicle coverage through a vehicle purchase by a customer of a vehicle manufacturer.

### DETAILED DESCRIPTION

Disclosed herein are methods and systems for providing vehicle coverage (e.g., auto insurance) as part of a purchase, e.g., a fuel purchase by a customer at a gas station or electric vehicle recharging station, or a vehicle purchase by a customer of a vehicle manufacturer who provides, e.g., automobiles through a subscription or membership model that bundles insurance or other benefits along with the vehicle purchase. The disclosed methods and systems provide disruptive models for distributing vehicle coverage while providing fuel suppliers and/or vehicle manufacturers with profitable new revenue streams, potentially eliminating “middle-men” or third-party insurance brokers to reduce costs, and directly connecting the cost of vehicle coverage to the risk associated with individual vehicle operators.

In a first aspect, the disclosed methods and systems comprise: a) providing a plurality of fueling stations, wherein the fueling stations of the plurality are configured to provide one or more types of fuel to one or more types of vehicle, and wherein each of the one or more types of vehicle may have a different mileage value for the one or more types of fuel; b) upon or subsequent to an event comprising a vehicle of the one or more types of vehicle receiving one or more types of fuel at a fueling station of the plurality, collecting: (i) fuel data comprising data for an amount of fuel received by the vehicle as measured by one or more fueling station sensors, and (ii) vehicle data comprising data for a vehicle identification number and data for a mileage value as measured by one or more vehicle sensors; c) determining, using a processor, a vehicle coverage value for the event based at least in part on the fuel data and the vehicle data; and d) providing vehicle coverage in an amount equal to the vehicle coverage value to an operator of the vehicle. Fueling stations, in specific instances of these methods and systems, may comprise any of a variety of wholesale or retail fueling locations known to those of skill in the art including, but not limited to, gasoline filling stations, diesel filling stations, biodiesel filling stations, electric vehicle recharging stations, or any combination thereof. Vehicles, in specific instances of these methods and systems, may comprise any of a variety of vehicles known to those of skill in the art including, but not limited to, gasoline-powered automobiles, diesel-powered automobiles, electric automobiles, hybrid automobiles, trucks, vans, motorcycles, electric bicycles, etc., or any combination thereof. Vehicle coverage, in specific instances of these methods and systems, may comprise any of a variety of different types of insurance or other guarantees of compensation for a specified loss, damage, illness, or death in return for payment of a premium that is bundled with a purchase of fuel.

In as second aspect, the disclosed methods and systems provide a disruptive model for selling, e.g., automobile insurance comprising: a) providing a plurality of fueling stations; and b) providing automobile insurance to a customer as part of a fuel purchase by the customer at any fueling station within the plurality; wherein an amount of automobile insurance provided as part of the purchase is proportional to an amount of fuel purchased. Again, fueling stations, in specific instances of these methods and systems, may comprise any of a variety of wholesale or retail fueling locations including, but not limited to, gasoline filling stations, diesel filling stations, biodiesel filling stations, electric vehicle recharging stations, or any combination thereof. Automobiles, in specific instances of these methods and systems, may comprise any of a variety of automobiles or other vehicles including, but not limited to, gasoline-powered automobiles, diesel-powered automobiles, electric automobiles, hybrid automobiles, trucks, vans, motorcycles, electric bicycles, etc., or any combination thereof. Automobile insurance, in specific instances of these methods and systems, may comprise any of a variety of different types of insurance or guarantees of compensation for a specified loss, damage, illness, or death in return for payment of a premium that is bundled with a purchase of fuel.

In a third aspect, the disclosed methods and systems provide a disruptive model for selling vehicle coverage or insurance comprising: a) providing vehicle coverage or insurance to a customer as part of a vehicle purchase from a manufacturer of the vehicle. Vehicles, in specific instances of these methods and systems, may comprise any of a variety of vehicles known to those of skill in the art including, but not limited to, gasoline-powered automobiles, diesel-powered automobiles, electric automobiles, hybrid automobiles, trucks, vans, motorcycles, electric bicycles, etc., or any combination thereof. Vehicle coverage, in specific instances of these methods and systems, may comprise any of a variety of different types of insurance or other guarantees of compensation for a specified loss, damage, illness, or death in return for payment of a premium that is bundled with a purchase of a vehicle.

There are many potential benefits to be derived from implementing the disclosed methods and systems for providing vehicle coverage. For example, in the context of providing automobile insurance through fuel sales at the gasoline pump or electric vehicle recharging station, potential benefits include: (i) distribution of auto insurance where the coverage is proportional to the mileage driven (and hence accurately reflects the degree of risk associated with the operation of the vehicle by the owner or user), (ii) elimination of auto insurers (“middle-men”) to reduce overall costs, (iii) creation of customer loyalty for the fuel companies and vendors that provide the vehicle insurance, e.g., through a “membership” model that strengthens the relationship between the fuel company or vendor and the customer/member, (iv) the leveraging of existing networks of fueling stations (e.g., filling stations and/or recharging stations) to create new revenue streams for the owners of the fueling stations, and (v) the enablement of fuel companies and/or recharging vendors to differentiate and redirect their businesses away from fuel sales. Vehicle manufactures may derive similar benefits by providing vehicle coverage through membership models that bundle the coverage with the purchase of a vehicle.

In some instances, the fuel company or fuel vendor that operates a series of fueling stations may either: (i) underwrite, administer and service the insurance business themselves, or (ii) underwrite the insurance business themselves, and outsource the administration and servicing of the client base to another company, or (iii) simply leverage their network of filling stations and/or recharging stations to create a nexus with fuel/recharging customers for distribution of auto insurance, and then cede the insurance business to another company which underwrites, administers, and services the business. Similarly, vehicle manufacturers that provide vehicle coverage through a subscription or membership model may choose to (i) underwrite, administer and service the insurance business themselves, or (ii) underwrite the insurance business themselves, and outsource the administration and servicing of the client base to another company, or (iii) simply leverage their network of vehicle showrooms to create a nexus with customers for distribution of auto insurance, and then cede the insurance business to another company which underwrites, administers, and services the business.

The disclosed methods and systems may revolutionize vehicle coverage through elimination of an entire industry-auto insurers-based on the large numbers of transactions enabled by providing coverage at the fuel pump or through a vehicle sale, while diversifying the fuel vendor's or vehicle manufacturer's balance sheet. Vehicle demand continues to grow as consumers struggle to find efficient means of transport while also protecting their investment and complying with insurance requirements. Fuel companies-whether providing gasoline, other forms of fuel, or battery recharging services-own a unique pumping station/recharging station nexus with the consumer which, if coupled with ongoing technological and societal trends, will provide a “partnership at the pump/recharging station” opportunity to deepen their relationship with the customer. Vehicle manufactures will gain a similar opportunity to deepen their relationship with the customer by providing vehicle coverage through membership models that bundle the coverage with the purchase of a vehicle.

Definitions: Unless otherwise defined, all of the technical terms used herein have the same meaning as commonly understood by one of ordinary skill in the art in the field to which this disclosure belongs.

As used in this specification and the appended claims, the singular forms “a”, “an”, and “the” include plural references unless the context clearly dictates otherwise. Any reference to “or” herein is intended to encompass “and/or” unless otherwise stated.

As used herein, the term “vehicle” may refer to any fuel- or electrically-powered mechanical system (or mechanism) designed to transport people and/or materials from one location to another. Examples include, but are not limited to, automobiles (cars), autonomous automobiles, trucks, vans, motorcycles, motorized scooters, electric bicycles, boats, airplanes (planes), helicopters, and drones. Furthermore, the term “automobile” may refer to any of a variety of gasoline-powered automobiles, diesel-powered automobiles, bio-diesel-powered automobiles, hydrogen-powered automobiles, electric automobiles, hybrid automobiles, and the like. Similarly, the terms “trucks”, “vans”, etc., may refer to gasoline-powered, diesel-powered, bio-diesel-powered, hydrogen-powered, electric-powered, or hybrid trucks, vans, etc. The disclosed methods and systems for providing vehicle coverage may apply to any of a variety of non-traditional vehicles, including emerging technologies such as drones which are increasingly being used for, e.g., geographical and agricultural survey, security, package delivery, and commercial real estate applications.

As used herein, the term “fuel” may refer to any form of energy-producing substance used to power a vehicle. Examples include but are not limited to gasoline (gas), diesel, bio-diesel, hydrogen, and electricity. Similarly, a “fueling station” may refer to any wholesale or retail location where one or more fuels in any of its forms is provided to a customer. Examples include, but are not limited to, gasoline filling stations, diesel filling stations, bio-diesel filling stations, hydrogen filling stations, electric vehicle recharging stations, or any combination thereof.

As used herein, the terms “fuel company” or “energy company” may refer to any company that produces and/or provides any form of fuel (including electricity) directly or indirectly to another company or to a customer. For example, a fuel company may be an oil company that produces, refines, and/or sells oil or refined oil products to other companies (e.g., distributors or vendors) or directly to customers through its own network of fueling stations. Similarly, the terms “fuel vendor” or “energy vendor” may refer to any company that purchases one or more types of fuel (including electricity) from one or more fuel companies and then resells the one or more types of fuel to customers through one or more fueling (or recharging) stations.

As used herein, the terms “vehicle coverage”, “vehicle insurance”, or simply “insurance” may refer to any form of insurance or other guarantee of compensation for a specified loss, damage, illness, or death in return for payment of a premium that is bundled with a purchase of fuel or a purchase of a vehicle. Examples include, but are not limited to, personal liability insurance, collision insurance, uninsured vehicle operator insurance, underinsured vehicle operator insurance, medical payments coverage insurance, personal injury protection insurance, gap insurance, comprehensive insurance, or any combination thereof.

The interplay of the energy and vehicle insurance industries: Fuel companies (or more generally, energy companies) understand both risk creation and risk mitigation. Oil companies, for example, extract raw materials from the ground whereby the production costs and future benefits can be hedged. This results in a very efficient “captive” financial model which uses the balance sheet to effectively manage the overall costs of a large pool of well-defined individual risks.

The nature and extent of vehicle insurance risk is ultimately created at the fuel pump or recharging station. Without providing fuel (or an electrical recharge, in the case of electric vehicles) there is no associated risk. Auto insurance risk, for example, only exists to the extent that there is fuel remaining in the vehicle. Thus, there is a pool of individual insurance risks that is created through the combined effect of every individual fuel purchase.

Each fueling/recharging event represents an individual risk which has definable risk characteristics in terms of both scope and user behavior. Energy companies have unique insights into their individual customers, which may be further supplemented by monitoring where fuel/charge is purchased and how it is utilized (including, for example, the type of vehicle). Energy companies (or energy vendors) are thus in a unique position to capitalize on the nexus between fuel/charge sales and risk creation. Historically, this harkens back to the fundamentally sound insurance practice of underwriting the risk by signing onto bills of lading at the point of shipping. The bill of lading in the presently disclosed business model is the receipt for the fuel/charge purchase, and the energy company becomes the “Lloyds of London” of vehicle insurance. The disclosed methods and systems enable the energy company to broaden its financial participation from its present focus on fuel/charge delivery to end-to-end participation in the process extending from extraction and processing of raw materials to the delivery of fuels/charge to the actual use of these fuels/charge by the end-user or customer (i.e., the opportunity to participate beyond the fueling station stage).

Transformative solution to the problem of providing cost-effective vehicle coverage: Delivering a traditionally required risk solution (i.e., vehicle insurance) in the most efficient manner possible at the point of nexus will capitalize on evolving technology and societal purchasing behavior. The energy company or vehicle manufacturer effectively owns the point of nexus (the pump/recharging station and pump/charge purchase, or the vehicle showroom and vehicle purchase) and is thus able to leverage these capabilities into a complimentary revenue stream which builds a diverse balance sheet.

Control of the nexus by the energy company or vehicle manufacturer allows for the pooling of millions of individual well-defined risks, which is the essence of a captive insurance model which creates a very beneficial balance sheet solution that includes revenue/profits from facilitating and otherwise retaining risk.

The energy company or vehicle manufacturer is in the position to source risks for its own capital model and/or partner with an existing insurance provider to create an association pool for specific customers. Furthermore, control of the nexus allows for transforming the delivery of the financial product (i.e., the coverage or insurance) itself Countries such as the United States have built regulatory systems over the years that distance the customer/buyer from the risk generation event through expensive processes involving intermediaries (brokers/insurers). E-platforms have had some success in carving out markets, but do not address the risk generation itself.

Today, energy companies have an increased need for differentiation. For example, one fuel company of which we are aware is considering the addition of charging stations for electric vehicles at its network of filling stations. India, as another example, recently allowed access to their market by outside fuel vendors in 2019, thus creating an incentive for local oil companies to retain existing customers in the face of increased competition by “premium” foreign brands. The people of India understand developing markets, value the traditional need for insurance, and embrace the technological wave that has changed the way traditional products are delivered. The people of India are brand conscious only to the extent that the brand delivers on its promises while understanding individual customers at the personal level. This disclosed methods and systems provide a solution for providing vehicle insurance that may differentiate a given energy company from all other competitors.

Traditional insurance products have an element of “paying for nothing” which is destructive to the insurance industry. The true value of insurance is known only by a few, and only at the time of making a claim, while many other customers see insurance as largely a significant cost with little obvious benefit. The latter is especially true for idle vehicles (e.g., vehicles that are idle due to owner usage preferences, the owner's medical condition, or for any number of other reasons) where the owners drive only a few miles in a given year and must pay for coverage that is not at parity with actual car usage. The disclosed methods and systems for providing vehicle insurance may eliminate the “pay for nothing” complaint of many insurance consumers/customers in that the coverage is directly tied to the amount of fuel purchased and thus to the amount of travel undertaken by the customer.

Energy companies and vehicle manufacturers are in a unique position to disrupt the very nature of the vehicle insurance industry based on sound risk-management principals. By focusing on risk-generation events, there will be wider appeal to the uninsured market and a solid financial benefit for the currently-insured market to motivate replacement of their current insurance providers. In addition, energy companies or vehicle manufacturers may through ancillary offerings/services generate a wealth of data that uniquely position them to define and monitor customer risk behaviors and vehicle characteristics. Lower uncertainty in estimating risk creates a competitive edge in pricing the cost of coverage for the risk itself

Overview of risk assessment and insurance cost: Referring again to India as an example, insurance rates in India are determined on a specified set of criteria and coverages, some of which are mandatory. Mandatory third-party coverage is determined by engine capacity and engine type and is issued by the Insurance Regulatory Authority of India (IRDAI). Optional comprehensive coverage includes Own Accident and Personal Accident, with cost criteria including the type of vehicle, the age of the vehicle, engine capacity, geographical location, and insured declared value (IDV: depreciating or non-depreciating). Other cost criteria may include the age and gender of the owner-driver, the profession of the owner, a voluntary deductible, a no claim bonus (NCB), anti-theft device installation, etc. Table 1 provides an illustration of representative costs for a new car (A; cost=5 Lacs) and a 5-year old used car (B; IDV=2 Lacs).

TABLE 1
Non-limiting example of representative
costs of auto insurance in India

| | Vehicle A | | Vehicle B | |
|---|---|---|---|---|
| Cost of traditional policy | Rs. 15,000 | | Rs 4,800 | |
| (1 year comprehensive) | | | | |
| Cost of mandatory coverage | Included above | | Included above | |
| Average distance driven | 15,000 | km | 15,000 | km |
| annually | | | | |
| Average distance per liter | 25 | km/liter | 25 | km/liter |
| of fuel | | | | |
| Average amount of fuel | 600 | liters | 600 | liters |

| | | |
|---|---|---|
| consumed annually | | |
| Approx. cost of insurance | Rs. 25/liter | Rs. 8/liter |
| per liter | | |
| Average fuel cost per liter | Rs. 75 | Rs. 75 |
| (no insurance included) | | |

If Vehicle A is driven only 12,500 kilometers, it will effectively pay Rs. 30/liter instead of Rs. 25/liter (20% as much for nothing extra) under a traditional insurance policy. Using one of the new insurance models disclosed herein (e.g., where the cost of insurance is bundled with fuel purchases), Vehicle A would be subject to an insurance cost of Rs. 12,500 instead of Rs. 15,000 (83% of the traditional cost).

Pricing constructs: The disclosed methods and systems for providing vehicle coverage may be implemented using one of at least two different possible pricing constructs.

(1) Subscription models: The energy company or vehicle manufacturer provides an agreement in advance to finance the cost of vehicle insurance through fuel/charge purchases or vehicle purchases respectively. This structure will allow for recovery of compulsory costs. There may also be a variable rate which to allow for optional comprehensive coverage on a participating basis with the owner.

(2) Pay-as-you-go models: The energy company or vehicle manufacturer may have an opportunity to work with government regulators to create a program whereby insurance is provided on a segmented basis which ensures that all vehicles are covered in an efficient way that does not require upfront costs or long-term commitment.

Implementation: In some countries, e.g., India, consumers more frequently access services through their phone compared to consumers in other regions. In some instances, the disclosed methods and systems may comprise the use of an efficient website or smart phone application (an “app”) to handle enrollment/subscription. Consumers in countries such as India also have a high usage rate for mobile payments (e.g., similar to Apple Pay or Samsung Pay) so the idea of using their phone to pay for fuel purchases at the pump or recharging station will not be alien to them.

In some instances, energy companies or vehicle manufacturers who offer vehicle coverage through one of the disclosed methods and systems may offer a “loyalty” card to customers that allows them to scan the card at a register or at a fuel pump or recharging station to activate insurance on a pay-as-you-go model, to manage a subscription or membership, or to add additional coverage as needed.

Such mobile phone applications and/or loyalty cards could also be used to verify information for drivers and/or vehicles including but not limited to driver's (or owner's or operator's) license number, age, sex, location of residence, driving record, etc., and vehicle identification number (VIN), vehicle model, vehicle age, vehicle engine or motor type, etc. Also, such applications and processes may be useful to collect more data on driving habits, to assess risk characteristics, and to show proof of insurance for government regulation.

### EXAMPLES

These examples are provided for illustrative purposes only and not to limit the scope of the claims provided herein.

### Prophetic Example 1—Vehicle Coverage Provided as Part of a Fuel Purchase

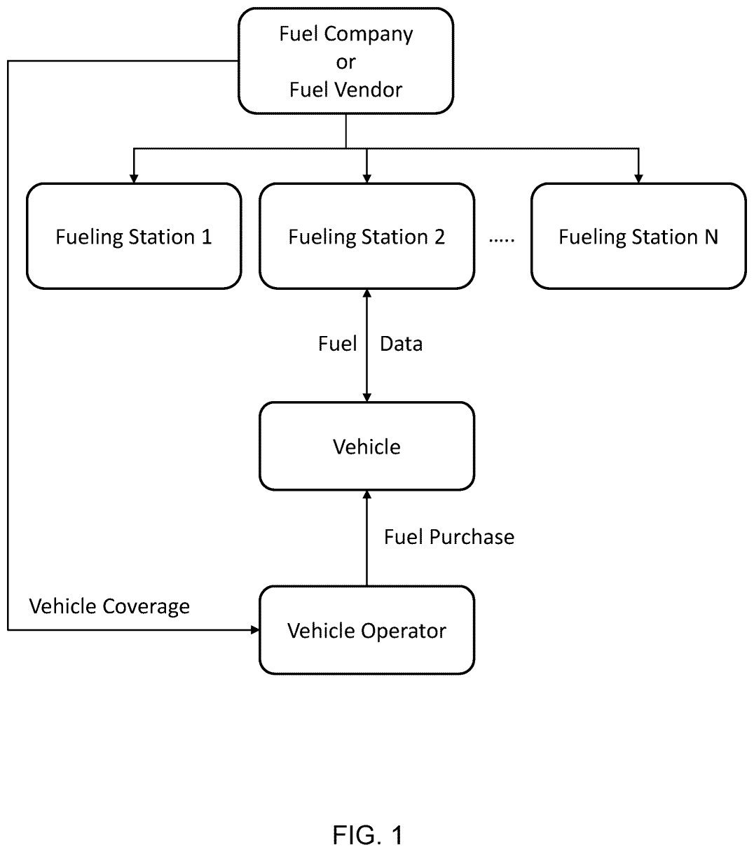

FIG. 1 provides a schematic, non-limiting example of a system for providing vehicle coverage as part of a fuel purchase by a vehicle owner or operator (i.e., a customer). A fuel company or fuel vendor that owns or operates a series of one or more fueling stations may opt to provide vehicle coverage directly to the customer as part of a fuel purchase.

The vehicles in this example may comprise automobiles (cars), autonomous automobiles, trucks, vans, motorcycles, motorized scooters, etc., or any combination thereof. Furthermore, the automobiles, trucks, vans, etc., may comprise any of a variety of gasoline-powered, diesel-powered, bio-diesel-powered, electric, or hybrid automobiles, trucks, vans, etc.

The series of one or more fueling stations in this example may comprise gasoline filling stations, diesel filling stations, bio-diesel filling stations, hydrogen filling stations, electric vehicle recharging stations, or any combination thereof. When a vehicle owner/operator arrives at a fueling station and purchases fuel, data about the fuel purchase (i.e., “fuel data”), e.g., the amount of fuel and/or the type of fuel transferred to the vehicle, is collected by one or more fueling station sensors. Also, “vehicle data” comprising, e.g., a vehicle identification number (VIN), vehicle manufacturer, vehicle model, vehicle engine type, vehicle age and/or total mileage (odometer reading) and/or vehicle fuel mileage, is transferred from one or more vehicle sensors to one or more fueling station sensors or processors.

Based on the data collected during or subsequent to the fuel purchase event, a fuel station processor (or a centralized processor that is linked to the fuel station processor via the internet) determines a vehicle coverage value for the fuel purchase event that is based at least in part on the fuel data and vehicle data. The vehicle coverage value is thus directly tied to the fuel purchase and amount of driving performed by the vehicle owner/operator and eliminates the role of traditional vehicle insurance providers.

In some instances, the fuel company or fuel vendor may underwrite, administer, and provide customer service for the vehicle coverage. In some instances, the fuel company or fuel vendor may underwrite the vehicle coverage, and at least one other company may administer and provide customer service for the vehicle coverage. In some instances, the fuel company or fuel vendor may simply provide the fueling stations, and at least one other company underwrites, administers, and provides customer service for the vehicle coverage.

A variety of purchase mechanisms may be implemented to support the bundling of vehicle coverage with fuel purchases. For example, in some instances, the vehicle coverage value is optionally tied to the use of a credit card provided by the fuel company or fuel vendor that provides the fueling stations. In some instances, the vehicle coverage value is optionally tied to the use of a mobile phone payment system provided by the fuel company or fuel vendor that provides the fueling stations. In some instances, the vehicle coverage value is optionally tied to a membership payment system provided by the fuel company or fuel vendor that provides the fueling stations.

A variety of adjustments to the vehicle coverage value may be applied to adjust for the risk characteristics associated with a specific vehicle and/or vehicle owner/operator. For example, in some instances, the vehicle coverage value is optionally tied to a vehicle identification number system. In some instances, the vehicle coverage value is adjusted according to the type of vehicle. In some instances, the vehicle coverage value is adjusted according to an accident risk assessment based at least in part on an age of the vehicle owner/operator. In some instances, the vehicle coverage is adjusted according to an accident risk assessment based at least in part on a sex of the vehicle owner/operator. In some instances, the vehicle coverage is adjusted according to an accident risk assessment based at least in part on a geographical location of the vehicle owner/operator. In some instances, the vehicle coverage is adjusted according to an accident risk assessment based at least in part on an average annual mileage driven by the vehicle owner/operator. In some instances, the vehicle coverage is adjusted according to an accident risk assessment based at least in part on a driving record for the vehicle owner/operator. In some instances, the vehicle coverage is adjusted according to the number of incident-free miles driven by the vehicle owner/operator.

A variety of adjustments to the vehicle coverage value may also be applied to adjust for the risk characteristics associated with a prescribed route of travel. For example, in some instances the vehicle coverage is adjusted based on historical data for traffic incidents along a prescribed route of travel. In some instances, the vehicle owner/operator may be offered alternative travel routes according to an accident risk assessment based at least in part on the prescribed driving route. In some instances, the prescribed driving route is provided by the vehicle owner/operator upon entering a starting location and a destination into a computer program or mobile phone application provided by the fuel company or fuel vendor. In some instances, the starting location is the location of the fueling station at which the receiving of the one or more types of fuel by the vehicle occurs. In some instances, the computer program or mobile phone application computes an accident frequency for two or more alternative driving routes between the starting location and the destination and selects the driving route for which the accident frequency is lowest as the projected driving route. In some instances, the computer program or mobile phone application computes a risk factor that is proportional to both an accident frequency and a driving time estimate that are calculated for two or more alternative driving routes between the starting location and the destination and selects the driving route for which the risk factor is lowest as the projected driving route. In some instances, the prescribed or alternative driving route is adjusted according to the time of day at which the vehicle owner/operator plans to travel. In some instances, the prescribed or alternative driving route is adjusted according to the day of the week on which the vehicle owner/operator plans to travel.

### Prophetic Example 2—Vehicle Coverage Provided as Part of a Subscription or Membership Model

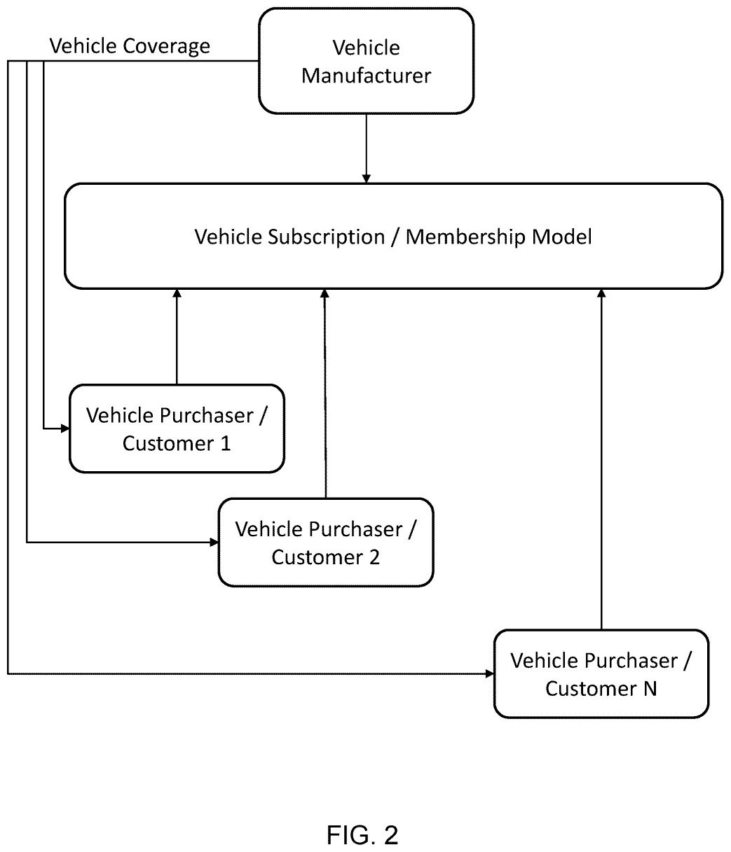

FIG. 2 provides a schematic, non-limiting example of a system for providing vehicle coverage as part of a subscription or membership model whereby the vehicle manufacturer provides vehicle coverage as part of the benefits of the subscription or membership, which in some instances may also comprise the vehicle manufacturer's primary mode for selling vehicles to customers.

Customers who have purchased a vehicle from the vehicle manufacturer may opt to become members (if not already subscribed as part of the vehicle purchase) and receive vehicle coverage that is bundled with the vehicle and/or membership purchase price. The vehicles in this example may comprise automobiles (cars), autonomous automobiles, trucks, vans, motorcycles, motorized scooters, etc., or any combination thereof. Furthermore, the automobiles, trucks, vans, etc., may comprise any of a variety of gasoline-powered, diesel-powered, bio-diesel-powered, electric, or hybrid automobiles, trucks, vans, etc. In some instances, the disclosed membership model may be used by manufacturers of other types of vehicles, e.g., electric bicycles, boats, airplanes (planes), helicopters, drones, and the like, to provide vehicle coverage to their customers.

In some instances, “vehicle data” comprising, e.g., a vehicle identification number (VIN), vehicle manufacturer, vehicle model, vehicle engine type, vehicle age and/or total mileage (odometer reading) and/or vehicle fuel mileage, may be collected and transferred at periodic or random intervals from one or more vehicle sensors to one or more sensors or processors located at one or more vehicle manufacturer sites (e.g., manufacturing plants, vehicle showrooms, etc.) or fueling stations that participate in the membership program. The one or more participating fueling stations in this example may comprise gasoline filling stations, diesel filling stations, bio-diesel filling stations, hydrogen filling stations, electric vehicle recharging stations, or any combination thereof. When a vehicle owner/operator arrives at a fueling station and purchases fuel, data about the fuel purchase (i.e., “fuel data”), e.g., the amount of fuel and/or the type of fuel transferred to the vehicle, may be collected by one or more fueling station sensors.

Based at least in part on the vehicle data collected during or subsequent to visits to the vehicle manufacturer's manufacturing plants or showrooms and/or on the fuel data collected during fuel purchase events, a processor (e.g., a centralized processor that is linked to the manufacturing plant, vehicle showroom, or fuel station sensors and processors via the internet) may determine a vehicle coverage value for each individual customer in the membership model. The vehicle coverage value is thus directly tied to the risk characteristics (e.g., the type of vehicle, the amount of driving or travel performed by the vehicle owner/operator, etc.) and eliminates the role of traditional vehicle insurance providers.

In some instances, the vehicle manufacturer may underwrite, administer, and provide customer service for the vehicle coverage. In some instances, the fuel vehicle manufacturer may underwrite the vehicle coverage, and at least one other company may administer and provide customer service for the vehicle coverage. In some instances, the vehicle manufacturer may simply provide the manufacturing plant(s) and/or vehicle showrooms, and at least one other company underwrites, administers, and provides customer service for the vehicle coverage.

In some instances, the vehicle coverage provided as part of the subscription or membership may comprise personal liability insurance, collision insurance, uninsured vehicle operator insurance, underinsured vehicle operator insurance, medical payments coverage insurance, personal injury protection insurance, gap insurance, comprehensive insurance, or any combination thereof.

In some instances, the amount or cost of the vehicle coverage provided as part of the subscription or membership may be adjusted according to an accident risk assessment based at least in part on an age of the customer. In some instances, the amount or cost of the vehicle coverage provided as part of the subscription or membership may be adjusted according to an accident risk assessment based at least in part on a sex of the customer. In some instances, the amount or cost of the vehicle coverage provided as part of the vehicle purchase may be adjusted according to an accident risk assessment based at least in part on a geographical location of the customer's place of residence. In some instances, the amount or cost of the vehicle coverage provided as part of the vehicle purchase may be adjusted according to an accident risk assessment based at least in part on an average annual mileage driven by the customer or an average annual number of hours flown by the customer. In some instances, the amount or cost of the vehicle coverage provided as part of the vehicle purchase may be adjusted according to an accident risk assessment based at least in part on a driving incident record or flight incident record for the customer. In some instances, the amount or cost of the vehicle coverage provided is adjusted according to the number of incident-free miles driven by the customer or according to a number of incident-free hours flown by the customer.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in any combination in practicing the invention. It is intended that the following claims define the scope of the invention and that methods and structures within the scope of these claims and their equivalents be covered thereby.

What is claimed is:

1. A method for providing insurance for a vehicle via a membership model comprising:
providing one or more vehicle sensors on a vehicle;
collecting vehicle data from the one or more vehicle sensors, wherein the vehicle data includes at least a distance travelled;
transmitting said vehicle data to a processor located remote from said vehicle;
determining risk characteristics for said vehicle based at least in part on vehicle data;
determining a vehicle coverage value based at least in part on said risk characteristics; and
providing insurance to said vehicle priced based at least in part on said vehicle coverage value.

2. The method of claim 1, wherein the insurance comprises personal liability insurance, collision insurance, uninsured vehicle operator insurance, underinsured vehicle operator insurance, medical payments coverage insurance, personal injury protection insurance, gap insurance, comprehensive insurance, or any combination thereof.

3. The method of claim 1, wherein the vehicle comprises an automobile, an autonomous automobile, a motorcycle, a motorized scooter, an electric bicycle, a boat, an airplane, a helicopter, or a drone.

4. The method of claim 3, wherein the vehicle comprises an electric vehicle.

5. The method of claim 1, wherein the manufacturer of the vehicle underwrites, administers, and provides customer service for the insurance.

6. The method of claim 1, wherein the manufacturer of the vehicle underwrites the insurance, and at least one other company administers and provides customer service for the insurance.

7. The method of claim 1, wherein an amount or cost of the insurance provided as part of the vehicle purchase is adjusted according to an accident risk assessment based at least in part on an age of the customer.

8. The method of claim 1, wherein an amount or cost of the insurance provided as part of the vehicle purchase is adjusted according to an accident risk assessment based at least in part on a sex of the customer.

9. The method of claim 1, wherein an amount or cost of the insurance provided as part of the vehicle purchase is adjusted according to an accident risk assessment based at least in part on a geographical location of the customer's place of residence.

10. The method of claim 1, wherein an amount or cost of the insurance provided as part of the vehicle purchase is adjusted according to an accident risk assessment based at least in part on an average annual mileage driven by the customer or an average annual number of hours flown by the customer.

11. The method of claim 1, wherein an amount or cost of the insurance provided as part of the vehicle purchase is adjusted according to an accident risk assessment based at least in part on a driving incident record or flight incident record for the customer.

12. The method of claim 1, wherein an amount or cost of the insurance provided is adjusted according to a number of incident-free miles driven by the customer or according to a number of incident-free hours flown by the customer.

13. The system of claim 1, further comprising:
receiving fuel data regarding an amount of fuel received by said vehicle; and
determining risk characteristics for said vehicle based at least in part on said fuel data.

14. A system for providing insurance for a vehicle via a membership model comprising:
a vehicle having one or more sensors collecting vehicle data during the operation of the vehicle;
said vehicle data including at least a distance travelled by said vehicle;
an insurance processor in data communication with said vehicle, said processor located remote from said vehicle;
said processor receiving said vehicle data from said vehicle;
said processor determining risk characteristics for said vehicle based at least in part on said vehicle data;
said processor determining a vehicle coverage value based at least in part on said risk characteristics; and
said insurance processor presenting an insurance contract based at least in part on said vehicle coverage value.

15. The system of claim 14, wherein the insurance comprises personal liability insurance, collision insurance, uninsured vehicle operator insurance, underinsured vehicle operator insurance, medical payments coverage insurance, personal injury protection insurance, gap insurance, comprehensive insurance, or any combination thereof.

16. The system of claim 14, wherein the vehicle comprises an automobile, an autonomous automobile, a motorcycle, a motorized scooter, an electric bicycle, a boat, an airplane, a helicopter, or a drone.

17. The system of claim 16, wherein the vehicle comprises an electric vehicle.

18. The system of claim 14, wherein the manufacturer of the vehicle underwrites, administers, and provides customer service for the insurance.

19. The system of claim 14, wherein the manufacturer of the vehicle underwrites the insurance, and at least one other company administers and provides customer service for the insurance.

20. The system of claim 14, further comprising:
said processor receiving fuel data regarding an amount of fuel received by said vehicle; and
said processor determining risk characteristics for said vehicle based at least in part on said fuel data.
